(19) United States
(12) Patent Application Publication
(10) Pub. No.: US 2021/0102041 A1
(43) Pub. Date: Apr. 8, 2021

(54) POLYOL PREMIXES, POLYURETHANE FOAM-FORMING COMPOSITIONS AND CLOSED-CELLED RIGID POLYURETHANE FOAMS FORMED THEREFROM

(71) Applicant: Covestro LLC, Pittsburgh, PA (US)

(72) Inventors: Stephen J. Harasin, Morgan, PA (US); Bruce H. Potts, Aliquippa, PA (US); Kenneth R. Riddle, Ambridge, PA (US)

(21) Appl. No.: 17/060,301

(22) Filed: Oct. 1, 2020

Related U.S. Application Data
(60) Provisional application No. 62/909,978, filed on Oct. 3, 2019.

(51) Int. Cl. C08J 9/12; C08L 83/04; C08L 71/00

(52) U.S. Cl. CPC C08J 9/122; C08L 83/04; C08J 2375/08; C08J 2203/02; C08J 2201/022; C08L 71/00

(57) ABSTRACT

Polyol premixes are described that are suitable for use in the preparation of polyurethane foam-forming reaction mixtures. These foam-forming reaction mixtures can produce closed-celled polyurethane foams exhibit a low level of water absorption. Also described are various uses of such reaction mixtures, including injecting the reaction mixture beneath at least a portion of an earth-supported structure and allowing the polyurethane foam-forming reaction mixture to react and form a closed-celled, rigid polyurethane foam beneath the earth-supported structure.

### FIELD

This specification relates to, among other things, polyol premixes suitable for preparing closed-celled rigid polyurethane foam-forming reaction mixtures, as well as to various uses of such reaction mixtures, including injecting the reaction mixture beneath at least a portion of an earth-supported structure and allowing the reaction mixture to react and form a closed-celled, rigid polyurethane foam beneath the earth-supported structure.

### BACKGROUND

Closed-celled rigid polyurethane foams are used in many applications, including for lifting earth-supported structures, such as concrete floors or slabs, which have settled or sunk on roadways, walkways or elsewhere. In such applications, a polyurethane foam-forming reaction mixture is injected into the ground under the earth-supported structure, where it raises the settled or sunken structure as the foam-forming reaction occurs.

Since, in such applications, the reaction mixture may be injected into various soil conditions, it is important that the resulting foam be resistant to the absorption of water so that initial density and other properties of the foam are maintained for a long period of time. Thus, in some cases, hydrophobic polyols, such as castor oil, are included as part of the composition that is used to produce the reaction mixture.

The use of hydrophobic polyols to accomplish resistance to water absorption is, however, not without its drawbacks. The hydrophobic polyol may negatively affect processing properties of the foam-forming reaction mixture, such as by increasing curing times. Hydrophobic polyols may have compatibility issues with polyisocyanates used in the foam-forming reaction mixture and they may react with water present in the foam-forming reaction mixture. They also can be relatively costly and can present manufacturing difficulties since incorporation of a hydrophobic polyol, such as castor oil, into a formulation will likely necessitate other polyol formulation changes in order to attain the necessary OH number of the polyol blend require to ensure that a 1:1 volume ratio of polyisocyanate component to polyol component is used, at a given isocyanate index, which may be necessary due to the mixing equipment used during application. In addition, a hydrophobic polyol may be a polyol component that is not commonly used at a particular manufacturing facility, thereby necessitating additional equipment or processes for their handling. Finally, inclusion of hydrophobic polyols, such as castor oil, in significant amounts can have a detrimental effect on physical properties of the resulting foam, such as compressive strength.

As a result, it would be desirable to provide polyol premixes that can be used to produce closed-celled rigid polyurethane foams that are resistant to water absorption. Moreover, it would be desirable to provide such premixes that do not require the use of significant amounts, or any amount, of a hydrophobic polyol, such as castor oil, to achieve such water absorption resistance. It would also be desirable for such premixes to not negatively affect other properties of the resulting foam, such as density, compressive strength, and closed-cell content.

The present invention was made in view of the foregoing.

### SUMMARY OF THE INVENTION

This specification is directed to polyol premixes. These premixes comprise: (a) a polyol; (b) a carbon dioxide chemical blowing agent; (c) an ester that does not contain Zerewitinoff-active hydrogen atoms; (d) a catalyst; and (e) a polydimethylsiloxane-polyalkyleneoxide copolymer having a weight average molecular weight of no more than 5000 gram/mole a silicon content of at least 12% by weight, based on the total weight of the polydimethylsiloxane-polyalkyleneoxide copolymer.

This specification also relates to closed-celled rigid polyurethane foams produced from such polyol premixes, as well as to various uses of such polyol premixes, including using the polyol premixes in a process in which a polyurethane foam-forming reaction mixture is injected beneath at least a portion of an earth-supported structure and the polyurethane foam-forming reaction mixture is allowed to react and form a closed-celled, rigid polyurethane foam beneath the earth-supported structure.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, unless otherwise expressly indicated, all numerical parameters are to be understood as being prefaced and modified in all instances by the term “about”, in which the numerical parameters possess the inherent variability characteristic of the underlying measurement technique used to determine the numerical value of the parameter. At the very least, but without limiting the application of the doctrine of equivalents to the claims, each numerical parameter described in this specification should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112 and 35 U.S.C. §132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used in this specification, the term “functionality”, when used with reference to an —OH functional material, refers to the average number of reactive hydroxyl groups, —OH, present per molecule of the —OH functional material that is being described. As used in this specification, the term “hydroxyl number” refers to the number of reactive hydroxyl groups available for reaction, and is expressed as the number of milligrams of potassium hydroxide equivalent to the hydroxyl content of one gram of a compound, such as a polyol, and is determined according to ASTM D4274-16.

As indicated, in certain embodiments, this specification is directed to polyol premixes that comprise a polyol. The polyol premixes of this specification may, and often do, comprise two or more different polyols. In certain implementations, for example, the polyol premix comprises two or more rigid polyols. As used herein, “rigid polyols” refers to relatively short-chained polyols suitable for the production of rigid polyurethane foams. More specifically, in some implementations, such rigid polyols include, without limitation, polyols, such as polyether polyols and polyester polyols, having a functionality of 2 to 8, such as 2 to 6 or 3 to 5, and an OH number of at least 200 mg KOH/g, such as at least 300 mg KOH/g, or, in some cases, at least 400 mg KOH /g, and up to 1000 mg KOH/g, up to 900 mg KOH/g, or, in some cases, up to 800 mg KOH/g.

Exemplary such polyols include polyoxyethylene glycols, polyoxyethylene triols, polyoxyethylene tetrols and higher functionality polyoxyethylene polyols, polyoxypropylene glycols, polyoxypropylene triols, polyoxypropylene tetrols and higher functionality polypropylene polyols, as well as mixtures thereof. When mixtures are used, the ethylene oxide and propylene oxide may be added simultaneously or sequentially to provide internal blocks, terminal blocks or random distribution of the oxyethylene groups and/or oxypropylene groups in the polyether polyol. Suitable starters or initiators for these polyols include, for example, ethylene glycol, propylene glycol, diethylene glycol, dipropylene glycol, tripropylene glycol, trimethylol-propane, glycerol, pentaerythritol, sorbitol, sucrose, ethylenediamine, and/or toluene diamine. The alkoxylation reaction may be catalyzed using any conventional catalyst including, for example, potassium hydroxide (KOH) or a double metal cyanide (DMC) catalyst.

Other suitable polyether polyols include alkylene oxide adducts of non-reducing sugars and sugar derivatives, alkylene oxide adducts of phosphorus and polyphosphorus acids, alkylene oxide adducts of polyphenols, and alkylene oxide adducts of polyhydroxyalkanes other than those described above, such as alkylene oxide adducts of, for example, 1,3-dihydroxypropane, 1,3-dihydroxybutane, 1,4-dihydroxybutane, 1,4-, 1,5- and 1,6-dihydroxyhexane, 1,2-, 1,3-, 1,4-1,6- and 1,8-dihydroxyoctant, 1,10-dihydroxydecane, glycerol, 1,2,4-tirhydroxybutane, 1,2,6-trihydroxyhexane, 1,1,1-trimethyl-olethane, 1,1,1-trimethylolpropane, pentaerythritol, caprolactone, polycaprolactone, xylitol, arabitol, sorbitol, and/or mannitol.

Other polyols which can be employed include the alkylene oxide adducts of non-reducing sugars, wherein the alkoxides have from 2 to 4 carbon atoms. Non-reducing sugars and sugar derivatives include sucrose, alkyl glycosides, such as methyl glycoside and ethyl glucoside, glycol glucosides, such as ethylene glycol glycoside, propylene glycol glucoside, glycerol glucoside, and 1,2,6-hexanetriol glucoside, as well as alkylene oxide adducts of the alkyl glycosides.

Also suitable are polyphenols, such as the alkylene oxide adducts thereof, wherein the alkylene oxides have from 2 to 4 carbon atoms. Among the polyphenols which are suitable are, for example, bisphenol A, bisphenol F, condensation products of phenol and formaldehyde, the novolac resins, condensation products of various phenolic compounds and acrolein, including the 1,1,3-tris(hydroxy-phenyl)propanes, condensation products of various phenolic compounds and glyoxal, glutaraldehyde, and other dialdehydes, including the 1,1,2,2-tetrakis(hydroxyphenol)ethanes.

The alkylene oxide adducts of phosphorus and polyphosphorus acid are also suitable. These include, as alkylene oxides, ethylene oxide, 1,2-epoxy-propane, the epoxybutanes, and/or 3-chloro-1,2-epoxypropane. Suitable acids include phosphoric acid, phosphorus acid, polyphosphoric acids, such as tripolyphosphoric acid, and/or the polymetaphosphoric acids.

In some implementations, the polyol(s) comprise any of the alkylene oxide reaction products described above (such as where propylene oxide and/or ethylene oxide are used as the alkylene oxide) wherein the content of ethylene oxide units in the polyol is relatively low. For example, in some of these implementations, the polyol(s) comprise, based on the molecular weight of the polyol, less than 30% by weight, less than 20% by weight, less than 10% by weight, less than 5% by weight, or, in some cases, less than 1% by weight of ethylene oxide units.

More particularly, in some implementations, the polyol premix comprises an amine-initiated, such as aliphatic amine-initiated, polyether polyol. In some implementations, such amine-initiated, such as aliphatic amine-initiated, polyols, have an OH number of at least 200 mg KOH/g, such as at least 400 mg KOH/g, or, in some cases at least 600 mg KOH/g, and up to 1000 mg KOH/g, up to 900 mg KOH/g, or, in some cases up to 800 mg KOH/g, and a functionality of 3 to 6, such as 3 to 5, 3.5 to 4.5, or 4.0.

As used herein, “aliphatic amine-initiated polyether polyol” refers to a polyether polyol prepared by reacting at least one alkylene oxide with an initiator in the presence of a suitable catalyst, in which the initiator comprises an aliphatic amine. Suitable alkylene oxides include, for example, ethylene oxide and/or propylene oxide. Suitable aliphatic amine initiators include: ammonia, ethylene diamine, hexamethylene diamine, methyl amine, diaminodiphenyl methane, aniline, and tetrahydroxyl ethyl ethylenediamine, as well as mixtures of any two or more thereof. In some embodiments, the aliphatic amine-initiated polyether polyol is the alkoxylation product of propylene oxide and ethylene diamine.

In some embodiments, the aliphatic amine-initiated polyether polyol is utilized in an amount of 10 to 80%, such as 20 to 70% by weight, or, in some cases, 30 to 60% by weight, based on the total weight of polyols in the polyol premix.

In addition to, or in lieu of, the foregoing aliphatic amine-initiated polyether polyol, the polyol premix may, in some cases, include an alkanolamine-initiated polyether polyol. As used herein, “alkanolamine-initiated polyether polyol” refers to a polyether polyol prepared by reacting an alkylene oxide with an initiator in the presence of a suitable catalyst, in which the initiator comprises an alkanolamine. Suitable catalysts including basic catalysts (such as sodium or potassium hydroxide or tertiary amines such as methyl imidazole) and DMC catalysts. In the polyol premixes described herein, each of the recited polyether polyols, including the “alkanolamine-initiated polyether polyol” and the “aromatic amine-initiated polyether polyol”, are different from each other.

As used herein, the term “alkanolamine” refers to compounds represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms. The dialkylene ether radical may be represented by the formula:

—R—O—R—

where each R represents a hydrocarbon radical having 2 to 3 carbon atoms.

Specific examples of suitable alkanolamines that may be used in the preparation of the alkanolamine-initiated polyether polyol include monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, as well as mixtures of any two or more thereof.

To prepare the alkanolamine-initiated polyether polyol, the alkanolamine is reacted with an alkylene oxide. Suitable alkylene oxides include ethylene oxide, propylene oxide, butylene oxide, styrene oxide, and epichlorohydrin, as well as mixtures of any two or more thereof.

In some implementations, the alkanolamine-initiated polyether polyol has an OH number of at least 500 mg KOH/g, such as 500 to 900 mg KOH/g, 600 to 800 mg KOH/g, or, in some cases, 680 to 720 mg KOH/g, and a functionality of 2.5 to 4, such as 2.5 to 3.5.

In some implementations, the alkanolamine-initiated polyether polyol is utilized in an amount of 10 to 80%, such as 20 to 70% by weight, or, in some cases, 30 to 60% by weight, based on the total weight of polyols in the polyol premix. When both an aliphatic amine-initiated polyether polyol and an alkanolamine-initiated polyether polyol are employed they, in some implementations, are employed in amounts such that they are present in a relative ratio, by weight, of 1:10 to 10:1, 1:5 to 5:1, or, in some cases, 1:2 to 2:1 or 1:1.5 to 1.5:1.

Further, in some implementations, the polyol premixes of this specification may comprise a saccharide-initiated polyether polyol. As used herein, “saccharide-initiated polyether polyol” refers to a polyether polyol prepared by reacting an alkylene oxide with a starter in the presence of a suitable catalyst, in which the starter comprises a saccharide. Examples of suitable alkylene oxides include ethylene oxide, propylene oxide, butylene oxide, styrene oxide, and epichlorohydrin, as well as mixtures of two or more thereof. Some examples of suitable saccharides are sucrose, sorbitol, and maltitol, as well as other mono-saccharides, di-saccharides, tri-saccharides and polysaccharides. Other initiators are often used in combination with the saccharide to prepare the saccharide-initiated polyether polyol. Saccharides can be co-initiated with for example, water, propylene glycol, glycerin, ethylene glycol, ethanol amine, or diethylene glycol, as well as mixtures of any two or more thereof.

In some implementations, the saccharide-initiated polyether polyol has an OH number of from 200 to 600 mg KOH/g, such as 300 to 550 mg KOH/g, or, in some cases, 400 to 500 mg KOH/g, and a functionality of 4 to 6, such as 4 to 5, or 4 to 4.5.

In some implementations, the saccharide-initiated polyether polyol is utilized in an amount of 1 to 20% by weight, such as 5 to 15% by weight, based on the total weight of the polyols in the polyol premix.

If desired, the polyol premixes of this specification may include additional compounds that contain isocyanate-reactive groups, such as chain extenders, crosslinking agents, hydrophobic polyols, such as castor oil, and/or other polyether polyols and polyester polyols not described above. Chain extenders and/or crosslinking agents include, for example, ethylene glycol, propylene glycol, butylene glycol, glycerol, diethylene glycol, dipropylene glycol, dibutylene glycol, trimethylolpropane, pentaerythritol, ethylene diamine, and diethyltoluenediamine, as well as mixtures of any two or more thereof. Polyester polyols may be prepared from, for example, an organic dicarboxylic acid having 2 to 12 carbon atoms, such as an aliphatic dicarboxylic acid having 4 to 6 carbon atoms, and a polyvalent alcohol, such as a diol or triol having 2 to 12 carbon atoms. Examples of the dicarboxylic acid are succinic acid, glutaric acid, adipic acid, suberic acid, azelaic acid, sebacic acid, decanedicarboxylic acid, maleic acid, fumaric acid, phthalic acid, isophthalic acid and terephthalic acid. Instead of a free dicarboxylic acid, a corresponding dicarboxylic acid derivative such as a dicarboxylic acid monoester or diester prepared by esterification with an alcohol having 1 to 4 carbon atoms or dicarboxylic anhydride can be used.

As previously indicated, the polyol premixes of this specification comprise a carbon dioxide generating chemical blowing agent, such as water and/or a formate-blocked amine.

In some of these implementations, the carbon dioxide generating chemical blowing agent, such as water, is utilized in an amount of 0.5 to 5.0% by weight, such as 1 to 4% by weight, or 1.0 to 3.0% by weight, or 1.0 to 2.0% by weight, based on the total weight of the polyol premix.

As also previously indicated, the polyol premixes of this specification further comprise an ester that does not contain Zerewitinoff-active hydrogen atoms, such as —OH, —NH₂ (primary amines), —NH— (secondary amines), —SH, or —CO₂H. In some implementations, the ester has a solubility in water of less than 0.02 g/l at 25° C. Moreover, in some implementations, the ester has a boiling point of at least 200° C., in some cases at least 250° C. Suitable esters include diesters, such as 2,2,4-trimethyl-1,3-pentanediol diisobutyrate (TXIB, sold by Eastman Chemical Company).

In some implementations, the foregoing ester is present in an amount of 10 to 50% by weight, such as 20 to 40% by weight, based on the total weight of the polyol premix. In some implementations, the polyol and the ester that does not contain Zerewitinoff-active hydrogen atoms are present in a combined amount of at least 90% by weight, such as at least 95% by weight, or at least 97% by weight, based on the total weight of the polyol premix.

The polyol premixes of this specification further comprise a catalyst. Suitable catalysts include any of those conventionally used in the production of closed-celled rigid polyurethane foams. Specific examples include, but are not necessarily limited to, organic metallic, such as organotin compounds, such as tin (II) octoate and dibutyl tin dilaurate, among others, and/or tertiary amines, such as N,N-dimethyl cyclohexylamine, and 1,4-diazabicyclo[2.2.2]octane, among others.

In some implementations, the catalyst is present in an amount of 0.01 to 4% by weight, 0.01 to 1% by weight, or, in some cases, 0.05 to 0.15% by weight, based on the total weight of the polyol premix.

The polyol premixes of the present specification further comprise a polydimethylsiloxane-polyalkyleneoxide copolymer having a weight average molecular weight of no more than 5000 gram/mole, such as no more than 4000 gram/mole, and a silicon content of at least 12% by weight, such as at 15% by weight, or, in some cases, at least 20% by weight, based on the total weight of the polydimethylsiloxane-polyalkyleneoxide copolymer. In some implementations, the polydimethylsiloxane-polyalkyleneoxide copolymer has a polydispersity index (“PDI”), M_{w}/Mₙ, of no more than 3.0, in some cases, no more than 2.0. In some implementations, the polydimethylsiloxane-polyalkyleneoxide copolymer has an OH number of at least 20 mg KOH/g, such as 20 to 100 mg KOH/g or 40 to 80 mg KOH/g.

In some implementations, the polydimethylsiloxane-polyalkyleneoxide copolymer is present in an amount of 0.01 to 4% by weight, 0.1 to 2% by weight, or, in some cases, 0.5 to 1.5% by weight, based on the total weight of the polyol premix.

For purposes of this specification, the silicon content of a polydimethylsiloxane-polyalkyleneoxide copolymer refers to the silicon content determined by dissolving a sample of the polydimethylsiloxane-polyalkyleneoxide copolymer in xylene and analyzing the sample by ICP-OES (inductively coupled plasma with optical emissions spectrometry) with organic torch.

For purposes of this specification, the molecular weight of a polydimethylsiloxane-polyalkyleneoxide copolymer (whether it be a number average molecular weight or a weight average molecular weight) refers to the molecular weight determined by gel-permeation chromatography (GPC) using a method based on DIN 55672-1 employing chloroform as the eluent with a mixed bed column (Agilent PL Gel; SDVB; 3 micron Pore dia: 1×Mixed-E+5 micron Pore dia: 2×Mixed-D), refractive index (RI) detection and calibrated with polyethylene glycol.

In fact, it was discovered, surprisingly, that simply by utilizing a polydimethylsiloxane-polyalkyleneoxide copolymer surfactant of the type described above it was possible to achieve a 70 to 90% reduction in water absorption of a closed-celled rigid polyurethane foam relative to a similar control formulation that utilized a polydimethylsiloxane-polyalkyleneoxide copolymer surfactant having a lower silicon content and/or a higher weight average molecular weight. Such improvements were even observed in formulations that did not include a hydrophobic polyol, such as castor oil, though excellent results were also observed in formulations also containing castor oil. In addition, other foam properties, such as closed-cell content, compressive strength and density remained acceptable.

The present specification also relates to methods for making a polyurethane foam using a polyol premix of the type described above, as well as to the resulting polyurethane foams. In these methods, the polyol premix is mixed with a polyisocyanate. As used herein, the term “polyisocyanate” refers to compounds that contain two or more isocyanate, i.e., —NCO, groups on the molecule.

Suitable organic polyisocyanates include aromatic, aliphatic, and cycloaliphatic polyisocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclo-hexane diisocyanate, isomers of hexahydro-toluene diisocyanate, isophorone diisocyanate, dicyclo-hexylmethane diisocyanates, 1,5-naphthylene diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates such as 2,4,6-toluene triisocyanate; and higher functionality polyisocyanates, such as 4,4′-dimethyl-diphenylmethane-2,2′,5,5′-tetraisocyanate and the polymethylene polyphenyl-polyisocyanates.

Undistilled or crude polyisocyanates may also be used. The crude toluene diisocyanate obtained by phosgenating a mixture of toluene diamines and the crude diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat. No. 3,215,652.

Modified isocyanates are obtained by chemical reaction of diisocyanates and/or polyisocyanates. Useful modified isocyanates include, but are not limited to, those containing ester groups, urea groups, biuret groups, allophanate groups, carbodiimide groups, isocyanurate groups, uretdione groups and/or urethane groups. Examples of modified isocyanates include prepolymers containing NCO groups and having an NCO content of from 25 to 35 weight percent, such as from 29 to 34 weight percent, such as those based on polyether polyols or polyester polyols and diphenylmethane diisocyanate.

In certain implementations, the polyisocyanate comprises a methylene-bridged polyphenyl polyisocyanate and/or a prepolymer of methylene-bridged polyphenyl polyisocyanates having an average functionality of from 1.8 to 3.5, such as from 2.0 to 3.1, isocyanate moieties per molecule and an NCO content of from 25 to 32 weight percent.

The methods for making a polyurethane foam of this specification comprise mixing the polyol premix and the polyisocyanate at an isocyanate index of from 90 to 150, such as 120 to 150, to produce a closed-celled rigid polyurethane foam. In some implementations, the polyol premix and the polyisocyanate are mixed at ratio, by volume, of polyisocyanate component to polyol premix of 1.1:1 to 1:1.1, such as 1.05:1 to 1: 1.05, or, in some cases 1:1.

In some implementations, the resulting polyurethane foam has water absorption, measured according to ASTM D2842-12, of less than 10 grams/1000 cm² and/or less than 10 grams/1000 cm³, in some cases no more than 5 grams/1000 cm² and/or less than 10 grams/1000 cm³.

In some implementations, the resulting polyurethane foam exhibits water absorption, measured according to Alabama Department of Transportation Procedure ALDOT-434-09 (entitled ABSORPTION OF WATER FOR POLYURETHANE PRODUCTS USED IN UNDERSEALING PAVEMENT) of less than 5%, less than 1.5%, in some cases, less than 1%, or less than 0.8%.

In some implementations, the resulting polyurethane foam has a density, measured according to ASTM 1622/D1622M-14, of no more than 5 lb/ft³, such as 4 to 5 lb/ft³, or, in some cases, 4 to 4.5 lb/ft³.

In some implementations, the resulting polyurethane foam has a closed cell content, measured according to ASTM D6226-15, of at least 60%, in some cases, at least 80%, and, in some cases, at least 85%.

As previously indicated, this specification also relates to using the polyol premixes described herein to correct, such as by levelling, an earth-supported structure, such as a concrete slab or floor or other pavement. In these implementations, a polyurethane foam-forming reaction mixture is formed by mixing the polyol premix with a polyisocyanate at an isocyanate index of 90 to 150, such as 120 to 150, and this reaction mixture is injected beneath at least a portion of an earth-supported structure where it is allowed to react and form a closed-celled, rigid polyurethane foam beneath the earth-supported structure.

In some implementations of these processes, the space between the earth-supported structure, such as a floor or slab, and the earth is reached by drilling at least one hole through the structure and injecting the components of the foam through the hole. As the foam expands between the earth and the structure, pressure is exerted on the structure, which forces the structure to rise. The amount and rate of upward movement can be controlled by controlling the rate of injection of the reaction mixture and the height of the sunken or broken portion may be measured in any desired fashion, prior to any further injection of the reaction mixture. The resulting closed-celled rigid polyurethane foam supports the previously sunken portion of the structure and also provides thermal insulation properties.

In some embodiments, a conventional foam spraying apparatus having a nozzle sized to fit closely into pre-formed holes in the earth-supported structure is used to inject the foam-forming reaction mixture beneath the structure. The foam spraying apparatus may be connected to a conduit, such as a hose, that leads to a high pressure mixer in which the polyol premix is mixed with the polyisocyanate.

Other embodiments of this specification relate to is directed to processes for strengthening geological formations in underground mining or other operations by introducing into the formation which is to be strengthened a polyurethane foam-forming reaction mixture produced using the polyol premixes of this specification. For example, in some implementations, a plurality of holes 2 to 6 meters in depth and 20 to 60 millimeters in diameter may be drilled into the formations to be strengthened and the foam-forming reaction mixture injected into these holes. The drill holes may be sealed off by a drill hole closure having a passage through which the reaction mixture can be injected by way of a pipe, a non-return valve being provided in the passage to prevent the reaction mixture from leaking out of the drill hole after injection has been completed. The injection may be carried out under pressures of up to 100 bar or more, for example.

When the drill holes have been sealed and the reaction mixture has been introduced, the mixture hardens it penetrates the formations under its own foaming pressure and at the same time fills the drill hole. The resulting polyurethane foam strengthens the geological formations by virtue of its adherence to coal or rock and its mechanical properties.

Various aspects of the subject matter described in this specification are set out in the following numbered clauses:

Clause 1. A polyol premix comprising: (a) a polyol; (b) a carbon dioxide chemical blowing agent; (c) an ester that does not contain Zerewitinoff-active hydrogen atoms; (d) a catalyst; and (e) a polydimethylsiloxane-polyalkyleneoxide copolymer having a weight average molecular weight of no more than 5000 gram/mole and a silicon content of at least 12% by weight, based on the total weight of the polydimethylsiloxane-polyalkyleneoxide copolymer.

Clause 2. The polyol premix of clause 1, wherein the polyol premix comprises two or more rigid polyols having a functionality of 2 to 8, 2 to 6, or 3 to 5, and an OH number of at least 200 mg KOH/g, at least 300 mg KOH/g, or at least 400 mg KOH/g, and up to 1000 mg KOH/g, up to 900 mg KOH/g, or up to 800 mg KOH/g.

Clause 3. The polyol premix of clause 1 or clause 2, wherein the polyol(s) comprises an alkylene oxide reaction product wherein the content of ethylene oxide units is, based on the molecular weight of the polyol, less than 30% by weight, less than 20% by weight, less than 10% by weight, less than 5% by weight, or less than 1% by weight.

Clause 4. The polyol premix of any one of clause 1 to clause 3, wherein the polyol premix comprises an amine-initiated, such as aliphatic amine-initiated, polyether polyol having an OH number of at least 200 mg KOH/g, at least 400 mg KOH/g, or at least 600 mg KOH/g, and up to 1000 mg KOH/g, up to 900 mg KOH/g, or up to 800 mg KOH/g, and a functionality of 3 to 6, 3 to 5, 3.5 to 4.5, or 4.0.

Clause 5. The polyol premix of clause 4, wherein the aliphatic amine-initiated polyether polyol is the alkoxylation reaction product of an alkylene oxide, such as ethylene oxide and/or propylene oxide, and an aliphatic amine initiator comprising ammonia, ethylene diamine, hexamethylene diamine, methyl amine, diaminodiphenyl methane, aniline, or tetrahydroxyl ethyl ethylenediamine, or a mixture of any two or more thereof, such as where the aliphatic amine-initiated polyether polyol is the alkoxylation product of propylene oxide and ethylene diamine.

Clause 6. The polyol premix of clause 4 or clause 5, wherein the aliphatic amine-initiated polyether polyol is present in an amount of 10 to 80%, 20 to 70%, or 30 to 60% by weight, based on the total weight of polyols in the polyol premix.

Clause 7. The polyol premix of one of clause 1 to clause 6, wherein the polyol premix comprises an alkanolamine-initiated polyether polyol that is the alkoxylation reaction product of an alkylene oxide (such as ethylene oxide and/or propylene oxide) and an initiator comprising an alkanolamine, such as an alkanolamine represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms, in which the dialkylene ether radical is represented by the formula:

—R—O—R—

where each R represents a hydrocarbon radical having 2 to 3 carbon atoms, such as where the alkanolamine comprises monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, or a mixture of any two or more thereof.

Clause 8. The polyol premix of clause 7, wherein the alkanolamine-initiated polyether polyol has an OH number of at least 500 mg KOH/g, 500 to 900 mg KOH/g, 600 to 800 mg KOH/g, or 680 to 720 mg KOH/g, and a functionality of 2.5 to 4 or 2.5 to 3.5.

Clause 9. The polyol premix of clause 7 or clause 8, wherein the alkanolamine-initiated polyether polyol is present in an amount of 10 to 80%, 20 to 70%, or 30 to 60% by weight, based on the total weight of polyols in the polyol premix.

Clause 10. The polyol premix of one of clause 7 to clause 9, wherein when both an aliphatic amine-initiated polyether polyol and an alkanolamine-initiated polyether polyol are present they are present in a relative ratio, by weight, of 1:10 to 10:1, 1:5 to 5:1, 1:2 to 2:1 or 1:1.5 to 1.5:1.

Clause 11. The polyol premix of one of clause 1 to clause 10, wherein the polyol premix comprises a saccharide-initiated polyether polyol that is the alkoxylation reaction product of an alkylene oxide (such as ethylene oxide and/or propylene oxide) with an initiator comprising a saccharide, such as sucrose, sorbitol, or maltitol, optionally co-initiated with water, propylene glycol, glycerin, ethylene glycol, ethanol amine, diethylene glycol, or a mixture of any two or more thereof.

Clause 12. The polyol premix of clause 11, wherein the saccharide-initiated polyether polyol has an OH number of 200 to 600 mg KOH/g, 300 to 550 mg KOH/g, or 400 to 500 mg KOH/g, and a functionality of 4 to 6, 4 to 5, or 4 to 4.5.

Clause 13. The polyol premix of one of clause 10 to clause 12, wherein the saccharide-initiated polyether polyol is present in an amount of 1 to 20% or 5 to 15% by weight, based on the total weight of the polyols in the polyol premix.

Clause 14. The polyol premix of one of clause 1 to clause 13, wherein the polyol premix comprises a hydrophobic polyol, such as castor oil.

Clause 15. The polyol premix of one of clause 1 to clause 14, wherein the carbon dioxide generating chemical blowing agent comprises water and/or a formate-blocked amine.

Clause 16. The polyol premix of one of clause 1 to clause 15, wherein the carbon dioxide generating chemical blowing agent is present in an amount of 0.5 to 5.0%, 1 to 4%, 1.0 to 3.0%, or 1.0 to 2.0% by weight, based on the total weight of the polyol premix.

Clause 17. The polyol premix of one of clause 1 to clause 16, wherein the ester that does not contain Zerewitinoff-active hydrogen atoms has a solubility in water of less than 0.02 g/l at 25° C. and/or a boiling point of at least 200° C. or at least 250° C.

Clause 18. The polyol premix of one of clause 1 to clause 17, wherein the ester that does not contain Zerewitinoff-active hydrogen atoms comprises a diester, such as 2,2,4-trimethyl-1,3-pentanediol diisobutyrate.

Clause 19. The polyol premix of one of clause 1 to clause 18, wherein the ester that does not contain Zerewitinoff-active hydrogen atoms is present in an amount of 10 to 50% or 20 to 40% by weight, based on the total weight of the polyol premix, and/or the polyol and the ester that does not contain Zerewitinoff-active hydrogen atoms are present in a combined amount of at least 90% by weight, at least 95% by weight or at least 97% by weight, based on the total weight of the polyol premix.

Clause 20. The polyol premix of one of clause 1 to clause 19, wherein the catalyst comprises a tertiary amine, such as N,N-dimethyl cyclohexylamine and/or 1,4-diazabicyclo[2.2.2]octane.

Clause 21. The polyol premix of one of clause 1 to clause 20, wherein the catalyst is present in an amount of 0.01 to 4%, 0.01 to 1%, or 0.05 to 0.15% by weight, based on the total weight of the polyol premix.

Clause 22. The polyol premix of one of clause 1 to clause 21, wherein the polydimethylsiloxane-polyalkyleneoxide copolymer has a silicon content of at least 15% by weight or at least 20% by weight, based on the total weight of the polydimethylsiloxane-polyalkyleneoxide copolymer.

Clause 23. The polyol premix of one of clause 1 to clause 22, wherein the polydimethylsiloxane-polyalkyleneoxide copolymer has a weight average molecular weight of no more than 4000 gram/mole.

Clause 24. The polyol premix of one of clause 1 to clause 23, wherein the polydimethylsiloxane-polyalkyleneoxide copolymer has a polydispersity index of no more than 3.0 or no more than 2.0.

Clause 25. The polyol premix of one of clause 1 to clause 23, wherein the polydimethylsiloxane-polyalkyleneoxide copolymer has an OH number of at least 20 mg KOH/g, 20 to 100 mg KOH/g, or 40 to 80 mg KOH/g.

Clause 26. A method of making a polyurethane foam comprising mixing the polyol premix of one of clause 1 to clause 25 with a polyisocyanate.

Clause 27. The method of clause 26, wherein the polyisocyanate comprises a methylene-bridged polyphenyl polyisocyanate and/or a prepolymer of methylene-bridged polyphenyl polyisocyanate having an average functionality of 1.8 to 3.5 or 2.0 to 3.1 isocyanate moieties per molecule and an NCO content of from 25 to 32 weight percent.

Clause 28. The method of clause 26 or clause 27, wherein the polyol premix and the polyisocyanate are mixed at an isocyanate index of 90 to 150 or 120 to 150.

Clause 29. A polyurethane foam produced by the method of one of clause 26 to clause 28.

Clause 30. The polyurethane foam of clause 29, wherein the polyurethane foam has water absorption, measured according to ASTM D2842-12, of less than 10 grams/1000 cm² and/or less than 10 grams/1000 cm³, such as no more than 5 grams/1000 cm² and/or less than 10 grams/1000 cm³.

Clause 31. The polyurethane foam of clause 29 or clause 30, wherein the polyurethane foam exhibits water absorption, measured according to Alabama Department of Transportation Procedure ALDOT-434-09 (entitled ABSORPTION OF WATER FOR POLYURETHANE PRODUCTS USED IN UNDERSEALING PAVEMENT) of less than 1.5%, less than 1%, or less than 0.8%.

Clause 32. The polyurethane foam of one of clause 29 to clause 31, wherein the polyurethane foam has a density, measured according to ASTM 1622/D1622M-14, of no more than 5 lb/ft³, 4 to 5 lb/ft³, or 4 to 4.5 lb/ft³.

Clause 33. The polyurethane foam of one of clause 29 to clause 32, wherein the polyurethane foam has a closed cell content, measured according to ASTM D6226-15, of at least 60%, at least 80% or at least 85%.

Clause 34. A method of using the polyol premix of one of clause 1 to clause 25, comprising: (a) mixing the polyol premix with a polyisocyanate at an isocyanate index of 90 to 150 to form a polyurethane foam-forming reaction mixture; (b) injecting the polyurethane foam-forming reaction mixture beneath at least a portion of an earth-supported structure; and (c) allowing the polyurethane foam-forming reaction mixture to react and form a closed-celled, rigid polyurethane foam beneath the earth-supported structure.

Clause 35. A method of strengthening a geological formation comprising introducing into the formation which is to be strengthened a polyurethane foam-forming reaction mixture produced using the polyol premix of one of clause 1 to clause 25.

The non-limiting and non-exhaustive examples that follow are intended to further describe various non-limiting and non-exhaustive embodiments without restricting the scope of the embodiments described in this specification.

### EXAMPLES

Foam-forming compositions were prepared using the following materials:

POLYOL 1: an ethylenediamine-initiated polyether polyol (100% propylene oxide epoxide block) having an OH number of 750-790 mg KOH/g and an average functionality of 4.0;

POLYOL 2: a sucrose-based polyether polyol (100% propylene oxide epoxide block) having an OH number of 398-422 mg KOH/g and an average functionality of 4.3;

POLYOL 3: a monoethanolamine-initiated polyether polyol (100% propylene oxide epoxide block) 685 to 715 mg KOH/g and an average functionality of 3.0;

POLYOL 4: a soybean oil based polyol having an OH number of 150 mg KOH/g and a functionality of 2 (commercially available as Honey beeTM HB-230 Polyol);

POLYOL 5: Aromatic oil blend, Viplex® 1700, Crowley Chemical Company, Inc.

POLYOL 6: Castor oil

CATALYST: 33% triethylenediamine dissolved in 67% dipropylene glycol (Commercially available as Dabco® 33-LV;

SURFACTANT 1: polyether polydimethylsiloxane copolymer, 6% measured Si content, 2010 g/mole measured number average molecular weight, and 12900 g/mole measured weight average molecular weight (commercially available as TEGOSTAB® B 8423);

SURFACTANT 2: organo-silicone, 9.3% measured Si content, 2560 g/mole measured number average molecular weight, and 11960 g/mole measured weight average molecular weight L5345;

SURFACTANT 3: organo-silicone, 11.8% measured Si content, 4300 g/mole measured number average molecular weight, and 14540 g/mole measured weight average molecular weight;

SURFACTANT 4: silicone polyether copolymer, 11.6% measured Si content, 1490 g/mole measured number average molecular weight, and 4590 g/mole measured weight average molecular weight (DC 193);

SURFACTANT 5: organo-silicone, 6.9% measured Si content, 3170 g/mole measured number average molecular weight, and 12800 g/mole measured weight average molecular weight;

SURFACTANT 6: polydimethylsiloxane-polyalkyleneoxide copolymer , OH number 54 mg KOH/g, 21.2% measured Si content, 1270 g/mole measured number average molecular weight, and 3190 measured weight average molecular weight;

TXIB: 2,2,4-trimethyl-1,3-pentanyl diisobutyrate (Eastman Chemical Company); and

ISOCYANATE: polymeric diphenylmethane diisocyanate (pMDI); NCO weight 31.5%; viscosity 200 mPa·s @ 25° C.; equivalent weight 133; functionality 2.8 (MONDUR® MR from Covestro LLC).

### Example 1

Polyol premixes were prepared using the ingredients and amounts (in parts by weight) set forth in Table 1.

TABLE 1

| Component | Example 1A | Example 1B | Example 1C | Example 1D | Example 1E | Example 1F |
|---|---|---|---|---|---|---|
| POLYOL 1 | 25.05 | 25.05 | 25.05 | 25.05 | 25.05 | 25.05 |
| POLYOL 2 | 24.05 | 24.05 | 24.05 | 24.05 | 24.05 | 24.05 |
| POLYOL 3 | 6.0 | 6.0 | 6.0 | 6.0 | 6.0 | 6.0 |
| CATALYST | 0.1 | 0.1 | 0.1 | 0.1 | 0.1 | 0.1 |
| SURFACTANT 1 | 1.2 | 3.5 | — | — | 1.2 | 1.2 |
| SURFACTANT 2 | — | — | 1.2 | — | — | — |
| SURFACTANT 3 | — | — | — | 1.2 | — | — |
| SURFACTANT 5 | — | — | — | — | — | — |
| SURFACTANT 6 | — | — | — | — | — | — |
| TXIB | 41.92 | 41.80 | 41.80 | 41.80 | 41.80 | 41.80 |
| DISTILLED WATER | 1.78 | 1.78 | 1.78 | 1.78 | 1.78 | 1.78 |
| POLYOL 4 | — | — | — | — | 12.0 | — |
| POLYOL 5 | — | — | — | — | — | 10.0 |
| POLYOL 6 | — | — | — | — | — | — |
| Component | Example 1G | Example 1H | Example 1I | Example 1J | Example 1K | Example 1L |
| POLYOL 1 | 30 | 30 | 30 | 25 | 26 | 26 |
| POLYOL 2 | 10 | 10 | 10 | 24 | 25 | 25 |
| POLYOL 3 | 30 | 30 | 30 | 6 | 7 | 7 |
| CATALYST | 0.1 | 0.1 | 0.1 | 0.1 | 0.1 | 0.1 |
| SURFACTANT 1 | 1.2 | — | — | — | — | — |
| SURFACTANT 2 | — | 1.2 | — | — | — | — |
| SURFACTANT 3 | — | — | 1.2 | — | — | — |
| SURFACTANT 4 | — | — | — | 1.2 | — | — |
| SURFACTANT 5 | — | — | — | — | 1.2 | — |
| SURFACTANT 6 | — | — | — | — | — | 1.2 |
| TXIB | 41.80 | 41.80 | 41.80 | 41.80 | 41.81 | 41.81 |
| DISTILLED WATER | 2.21 | 2.21 | 2.21 | 1.9 | 1.9 | 1.9 |
| POLYOL 4 | — | — | — | — | — | — |
| POLYOL 5 | — | — | — | — | — | — |
| POLYOL 6 | 30 | 30 | 30 | — | — | — |

Foams were prepared by the following procedure: All foams were prepared using a Hennecke Mini-Rim high-pressure foam machine. The polyol premix and isocyanate were combined at a ratio of 100/100 by volume. The liquid output was maintained at a constant 30° C. for POLYOL PREMIX and 30° C. for ISOCYANATE with an output range of 100 to 200 grams/second with a pour pressure of 103 bar. The reactant foam was poured into a box having dimensions −12 inches by 12 inches by 4 inches (4.7 cm×4.7 cm×1.58 cm) so that the reactant foam rose up above the sides of the box. The foam was allowed to cure overnight and samples for testing were cut out of the blocks of foam.

The foams were tested for various properties and the results are set forth in Table 2. Except for the Water Bucket test (AL DOT 434) which is a result of one test measurement, the results reflect the average of 3 measurements, except where otherwise indicated.

TABLE 2

| Property | Test Method | Example 1A | Example 1B | Example 1C | Example 1D | Example 1E | Example 1F |
|---|---|---|---|---|---|---|---|
| Density lb/ft³ | D 1622 | 4.44 | 4.63 | 4.4 | 4.5 | 5.0 | 4.2** |
| Compressive Modulus (psi) | D1621 | 2437* | 2044 | 2554 | 2022 | 2461 | — |
| Compressive Str @10% | D1621 | 64* | 66 | 63 | 65 | 83 | — |
| Compressive Str @5% | D2127 | 67* | 66 | 67 | 64 | 80 | — |
| Compressive Str @Yield | D2127 | 69* | 67 | 68 | 66 | 84 | — |
| Compressive Modulus (psi) WET | D1621 | 2013* | — | — | — | — | — |
| Compressive Str @10% WET | D1621 | 60* | — | — | — | — | — |
| Compressive Str @5% WET | D1621 | 62* | — | — | — | — | — |
| Compressive Str @Yield WET | D1621 | 64* | — | — | — | — | — |
| Water Absorption g/1000 cm 2 | D 2842 | 50 | 4.1 | 3.0 | 3.0 | 2.9 | 4.5** |
| Water Absorption g/1000 cm 3 | D 2842 | 38 | 4.9 | 3.5 | 3.5 | 5.7 | 6.6** |
| Flex Modulus | D 790 | — | 1571 | 2078 | 1722 | 1741 | — |
| Flex Str | D 790 | — | 77 | 98 | 81 | 83 | — |
| % Closed Cells | D 6226 | — | 90 | 82 | 50 | 88 | 39** |
| Shear Modulus | C 273 | — | 1041 | 1077 | 1084 | 1180 | — |
| Shear Stress | C 273 | — | 58 | — | 55 | 68 | — |
| Tensile Str Ultimate | D 1623 | — | 106 | 89 | 93 | 112 | — |
| Water Bucket Shot - g absorbed | AL DOT 434 | 287 | 348 | 182 | 144 | 126 | 130 |
| Water Bucket % | AL DOT 434 | 3.3 | 3.9 | 1.8 | 1.6 | 1.4 | 1.5 |
| Property | Test Method | Example 1G | Example 1H | Example 1I | Example 1J | Example 1K | Example 1L |
| Density (lb/ft³) | D 1622 | 4.9 | 4.9 | 5.0 | 4.0 | 4.0* | 4.1 |
| Compressive Modulus (psi) | D1621 | 2162 | 2383 | 2733 | 1843 | 2132* | 2059 |
| Compressive Str @10% | D1621 | 73 | 76 | 77 | 49 | 50* | 53 |
| Compressive Str @5% | D2127 | 69 | 77 | 81 | 51 | 50* | 56 |
| Compressive Str @Yield | D2127 | 77 | 81 | 82 | 52 | 54* | 57 |
| Compressive Modulus (psi) WET | D1621 | — | — | — | — | — | — |
| Compressive Str @10% WET | D1621 | — | — | — | — | — | — |
| Compressive Str @5% WET | D1621 | — | — | — | — | — | — |
| Compressive Str @Yield WET | D1621 | — | — | — | — | — | — |
| Water Absorption g/1000 cm² | D 2842 | 6.2 | 24.9 | 7.6 | 8.4 | 10.9* | 4.8 |
| Water Absorption g/1000 cm³ | D 2842 | 7.4 | 29 | 9.1 | 9.8 | 13.2* | 5.4 |
| Flex Modulus | D 790 | 1950 | 2043 | 2194 | 1547 | 1611* | 1625 |
| Flex Str | D 790 | 91 | 93 | 98 | 78 | 79* | 78 |
| % Closed Cells | D 6226 | 91 | 91 | 86 | 45 | 81* | 64 |
| Shear Modulus | C 273 | 1086 | 1175 | 1145 | 942 | — | 921 |
| Shear Stress | C 273 | 66 | 67 | — | 53 | — | 48 |
| Tensile Str Ultimate (psi) | D 1623 | 100 | 103 | 106 | 91 | 80* | 83 |
| Water Bucket Shot - g absorbed | AL DOT 434 | 46 | 17 | 10 | 169 | 108 | 69 |
| Water Bucket % | AL DOT 434 | 0.47 | 0.18 | 0.1 | 1.8 | 1.1 | 0.74 |

*reported result is an average of two measurement
**reported result is a single measurement

### Example 2

Polyol premixes were prepared using the ingredients and amounts (in parts by weight) set forth in Table 3.

TABLE 3

| | Example | Example | Example | Example |
|---|---|---|---|---|
| Component | 2A | 2B | 2C | 2D |
| POLYOL 1 | 25.00 | 26.00 | 26.00 | 20.65 |
| POLYOL 2 | 25.00 | 25.00 | 25.00 | 6.88 |
| POLYOL 3 | 6.00 | 7.00 | 7.00 | 20.65 |
| SURFACTANT 1 | 1.20 | — | — | — |
| SURFACTANT 6 | — | 3.00 | 5.00 | 5.00 |
| TXIB | 41.90 | 41.80 | 41.80 | 28.77 |
| POLYOL 6 | — | — | — | 20.65 |
| WATER | 1.78 | 1.90 | 1.90 | 1.51 |
| CATALYST | 0.10 | 0.10 | 0.10 | 0.07 |

Foams were prepared by the following procedure: Polyol premix and isocyanate were both maintained at a temperature of 25° C. and combined at a ratio of 100/100 by volume. The mixture was mixed using a high speed mixer at 5000 rpm and was poured into a 12 inch×12 inch×4 inch box. Sufficient quantity was mixed so the reacting foam rose above the sides of the container. Foams were allowed to cure overnight and then submitted for testing.

The foams were tested for density and water absorption. Results are set forth in Table 4.

TABLE 4

| | Test | Example | Example | Example | Example |
|---|---|---|---|---|---|
| Property | Method | 2A | 2B | 2C | 2D |
| Density lb/ft³ | D 1622 | 4.23 | 4.21 | 4.22 | 4.65 |
| Water Absorption | D 2842 | 33.37 | 14.21 | 15.76 | 4.65 |
| g/1000 cm 2 | | | | | |
| Water Absorption | D 2842 | 38.66 | 16.49 | 18.26 | 5.42 |
| g/1000 cm 3 | | | | | |

### Example 3

Polyol premixes were prepared using the ingredients and amounts (in parts by weight) set forth in Table 5.

TABLE 5

| Component | Example 3A | Example 3B | Example 3C | Example 3D | Example 3E | Example 3F |
|---|---|---|---|---|---|---|
| POLYOL 1 | 20.65 | 20.65 | 20.65 | 20.65 | 20.65 | 25.05 |
| POLYOL 3 | 20.65 | 20.65 | 20.65 | 20.65 | 20.65 | 6 |
| POLYOL 2 | 6.88 | 6.88 | 6.88 | 6.88 | 6.88 | 24.05 |
| SURFACTANT 4 | 0.83 | — | — | — | — | — |
| SURFACTANT 5 | — | 0.83 | — | — | — | — |
| SURFACTANT 6 | — | — | 0.83 | — | — | — |
| SURFACTANT 3 | — | — | — | 0.83 | — | — |
| SURFACTANT 1 | — | — | — | — | 0.83 | 1.2 |
| TXIB | 28.77 | 28.77 | 28.77 | 28.77 | 28.77 | 41.92 |
| POLYOL 6 | 20.65 | 20.65 | 20.65 | 20.65 | 20.65 | — |
| DISTILLED WATER | 1.51 | 1.51 | 1.51 | 1.51 | 1.51 | 1.78 |
| CATALYST | 0.07 | 0.07 | 0.07 | 0.07 | 0.07 | 0.1 |

Foams were prepared by the following procedure: All foams were prepared using a Hennecke Mini-Rim high-pressure foam machine. The polyol premix and isocyanate were combined at a ratio of 100/100 by volume. The liquid output was maintained at a constant 30° C. for POLYOL PREMIX and 30° C. for ISOCYANATE with an output range of 100 to 200 grams/second with a pour pressure of 103 bar. The reactant foam was poured into a box having dimensions −12 inches by 12 inches by 4 inches (4.7 cm×4.7 cm×1.58 cm) so that the reactant foam rose up above the sides of the box. The foam was allowed to cure overnight and samples for testing were cut out of the blocks of foam.

The foams were tested for various properties and the results are set forth in Table 6. All results reflect the average of 3 measurements, except where otherwise indicated.

TABLE 2

| Property | Test Method | Ex. 3A | Ex. 3B | Ex. 3C | Ex. 3D | Ex. 3E | Ex. 3F |
|---|---|---|---|---|---|---|---|
| Density (lb/ft³) | D 1622 | 5.8 | 5.6 | 5.6 | 5.5 | 5.0 | 4.3 |
| Compressive Modulus (psi) | D1621 | 3381 | 3163 | 2981 | 3261 | 2294 | 1942 |
| Compressive Str @10% | D1621 | 100 | 90 | 90 | 88 | 79 | 56 |
| Compressive Str @5% | D2127 | 107 | 100 | 98 | 96 | 83 | 60 |
| Compressive Str @Yield | D2127 | 108 | 100 | 100 | 98 | 86 | 61 |
| Water Absorption g/1000 cm² | D 2842 | 3.1 | 9.6 | 3.7 | 6.9 | 3.5 | 4.7 |
| Water Absorption g/1000 cm³ | D 2842 | 3.7 | 12.2 | 4.5 | 8.3 | 4.1 | 5.6 |
| % Closed Cells | D 6226 | 72 | 82 | 81 | 83 | 79 | 62 |
| Tensile Str Ultimate (psi) | D 1623 | 132 | 95 | 125 | 145 | 119 | 95 |
| Water Bucket % | AL DOT 434 | 8.3 | 10.4 | 3.8 | 6.9 | 7.4 | 21.9 |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. §112, first paragraph, and 35 U.S.C. §132(a).

What is claimed is:

1. A polyol premix comprising:
(a) a polyol;
(b) a carbon dioxide generating chemical blowing agent;
(c) an ester that does not contain Zerewitinoff-active hydrogen atoms;
(d) a catalyst; and
(e) a polydimethylsiloxane-polyalkyleneoxide copolymer having a weight average molecular weight of no more than 5000 gram/mole and a silicon content of at least 12% by weight, based on the total weight of the polydimethylsiloxane-polyalkyleneoxide copolymer.

2. The polyol premix of claim 1, wherein the polyol premix comprises an aliphatic amine-initiated polyether polyol having an OH number of at least 400 mg KOH/g and up to 800 mg KOH/g, and a functionality of 3.5 to 4.5.

3. The polyol premix of claim 2, wherein the aliphatic amine-initiated polyether polyol is present in an amount of 20 to 70% by weight, based on the total weight of polyols in the polyol premix.

4. The polyol premix of claim 2, wherein the polyol premix comprises an alkanolamine-initiated polyether polyol having an OH number of 500 to 900 mg KOH/g and a functionality of 2.5 to 3.5.

5. The polyol premix of claim 4, wherein the aliphatic amine-initiated polyether polyol and the alkanolamine-initiated polyether polyol are present in a relative ratio, by weight, of 1:5 to 5:1.

6. The polyol premix of claim 4, wherein the polyol premix comprises a saccharide-initiated polyether polyol having an OH number of 200 to 600 mg KOH/g and a functionality of 4 to 6.

7. The polyol premix of claim 6, wherein the saccharide-initiated polyether polyol is present in an amount of 5 to 15% by weight, based on the total weight of the polyols in the polyol premix.

8. The polyol premix of claim 1, wherein the ester that does not contain Zerewitinoff-active hydrogen atoms comprises a diester.

9. The polyol premix of claim 8, wherein the diester comprises 2,2,4-trimethyl-1,3-pentanediol diisobutyrate.

10. The polyol premix of claim 1, wherein the ester that does not contain Zerewitinoff-active hydrogen atoms is present in an amount of 10 to 50% by weight, based on the total weight of the polyol premix.

11. The polyol premix of claim 1, wherein the polyol and the ester that does not contain Zerewitinoff-active hydrogen atoms are present in a combined amount of at least 95% by weight, based on the total weight of the polyol premix.

12. The polyol premix of claim 1, wherein the polydimethylsiloxane-polyalkyleneoxide copolymer has a silicon content of at least 15% by weight, based on the total weight of the polydimethylsiloxane-polyalkyleneoxide copolymer.

13. The polyol premix of claim 1, wherein the polydimethylsiloxane-polyalkyleneoxide copolymer has a silicon content of at least 20% by weight, based on the total weight of the polydimethylsiloxane-polyalkyleneoxide copolymer.

14. The polyol premix of claim 1, wherein the polydimethylsiloxane-polyalkyleneoxide copolymer has a polydispersity index of no more than 3.0.

15. The polyol premix of claim 1, wherein the polydimethylsiloxane-polyalkyleneoxide copolymer has an OH number of 40 to 80 mg KOH/g.

16. The polyol premix of claim 1, wherein the polyol and the ester that does not contain Zerewitinoff-active hydrogen atoms are present in a combined amount of at least 97% by weight, based on the total weight of the polyol premix.

17. A method of making a polyurethane foam comprising mixing the polyol premix of claim 1 with a polyisocyanate at an isocyanate index of 90 to 150.

18. The method of claim 17, wherein the polyisocyanate comprises a methylene-bridged polyphenyl polyisocyanate and/or a prepolymer of methylene-bridged polyphenyl polyisocyanates having an average functionality of 1.8 to 3.5 isocyanate moieties per molecule and an NCO content of from 25 to 32 weight percent.

19. A polyurethane foam produced by the method of claim 17.

20. A method comprising:
(a) mixing the polyol premix of claim 1 with a polyisocyanate at an isocyanate index of 90 to 150 to form a polyurethane foam-forming reaction mixture;
(b) injecting the polyurethane foam-forming reaction mixture beneath at least a portion of an earth-supported structure; and
(c) allowing the polyurethane foam-forming reaction mixture to react and form a closed-celled, rigid polyurethane foam beneath the earth-supported structure.
